(19) United States
(12) Patent Application Publication
(10) Pub. No.: US 2010/0235376 A1
(43) Pub. Date: Sep. 16, 2010

(54) METHOD AND APPARATUS FOR ON-DEMAND CONTENT MAPPING

(75) Inventors: Jari Pekka Sukanen, Espoo (FI); Marko Eemeli Takanen, Espoo (FI); Toni Laurila, Helsinki (FI)

Correspondence Address: DITTHAVONG MORI & STEINER, P.C., 918 Prince Street, Alexandria, VA, 22314, US

(73) Assignee: Nokia Corporation, Helsinki (FI)

(21) Appl. No.: 12/401,062

(22) Filed: Mar. 10, 2009

(51) Int. Cl. G06F 17/30

(52) U.S. Cl. 707/769; 707/E17.014

(57) ABSTRACT

An approach is provided for mapping content, such as audio files, to associated metadata about the content. The approach includes initiating a search for local metadata associated with particular content. It is determined whether the local metadata is insufficient. A request for metadata associated with the particular content is generated, if the local metadata is insufficient. The request is sent to a metadata service to obtain result data including metadata for the particular content. A search of the result data from the metadata service is initiated based on a description of the particular content to obtain most relevant metadata of the result data.

### BACKGROUND

Content sharing applications have been one of the most widely used and popular applications over the Internet. At the same time, the use of wireless communication devices has become pervasive, and is rapidly overtaking the use of traditional wired devices. For example, one popular area involves the sharing of audio files and mapping those audio files to rich metadata that describes and supports the use of those files. Because available media are so voluminous, the creation and mapping of the associated metadata introduce a number of engineering challenges. For instance, data management as well as network resource management issues are of concern, as these issues impact network performance, and ultimately the user experience.

### SOME EXAMPLE EMBODIMENTS

Therefore, there is a need, when requesting content for a user, to obtain the richest possible metadata (i.e., content mapping) about the content and timely provide that metadata in a way that conserves network resources.

According to one embodiment, a computer-readable storage medium carries one or more sequences of one or more instructions which, when executed by one or more processors, cause the one or more processors to at least perform the steps of initiating a search for local metadata associated with a particular content and determining whether the local metadata is insufficient. The one or more processors are caused to perform steps further comprising generating a request for metadata associated with the particular content, if the local metadata is insufficient; and initiating sending the request to a metadata service to obtain result data including metadata for the particular content. The one or more processors are caused to perform steps further comprising initiating search of the result data from the metadata service based on a description of the particular content to obtain most relevant metadata of the result data.

According to another embodiment, an apparatus comprises a processor and a memory storing executable instructions that, if executed, cause the apparatus to perform initiating a search for local metadata associated with a particular content and determining whether the local metadata is insufficient. The processor and memory are also configured to generate a request for metadata associated with the particular content, if the local metadata is insufficient; and initiate sending the request to a metadata service to obtain result data including metadata for the particular content. The processor and memory are also configured to initiate search of the result data from the metadata service based on a description of the particular content to obtain most relevant metadata of the result data.

According to another embodiment, a method comprises initiating a search for local metadata associated with a particular content and determining whether the local metadata is insufficient. The method also generates a request for metadata associated with the particular content, if the local metadata is insufficient; and initiates sending the request to a metadata service to obtain result data including metadata for the particular content. The method also initiates search of the result data from the metadata service based on a description of the particular content to obtain most relevant metadata of the result data.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system for content mapping, according to one embodiment;

FIG. 1B is a diagram of components of a content service module, according to one embodiment;

FIG. 2A is a flowchart of a process for content mapping, according to one embodiment;

FIG. 2B is a flowchart of a process for one or more steps of the content mapping process of FIG. 2A, according to one embodiment;

FIG. 3A is a diagram of a request metadata message, according to one embodiment;

FIG. 3B is a diagram of a metadata results message, according to one embodiment;

FIG. 4 is a flowchart of a process for a content mapper client, according to one embodiment;

FIG. 5 is a time sequence diagram that illustrates a sequence of messages and processes for content mapping, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a terminal that can be used to implement an embodiment of the invention.

### DETAILED DESCRIPTION OF EXAMPLE EMBODIMENTS

A method, apparatus, and software for content mapping are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to music metadata and mapping, it is recognized by one of ordinary skill in the art that the embodiments of the inventions have applicability to any type of content playback (e.g., video and games) involving any device (e.g., wired and wireless local device or both local and remote wired or wireless devices) capable of playing content, or capable of communication with such a device. As used herein, content or media includes digital sound, digital images, digital games, and digital videos (such as music videos, news clips and theatrical videos) and any other digital media.

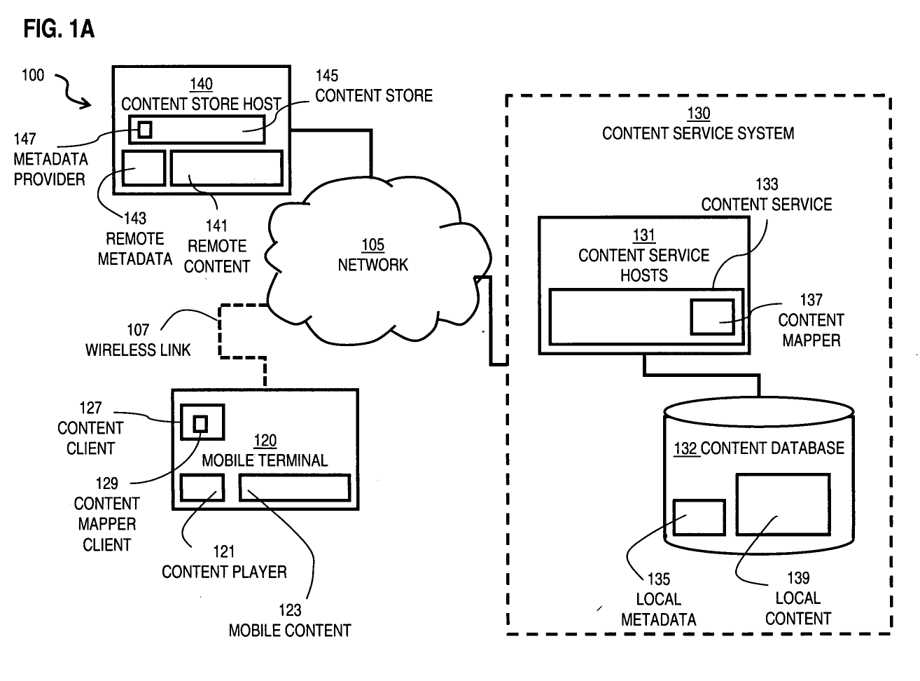

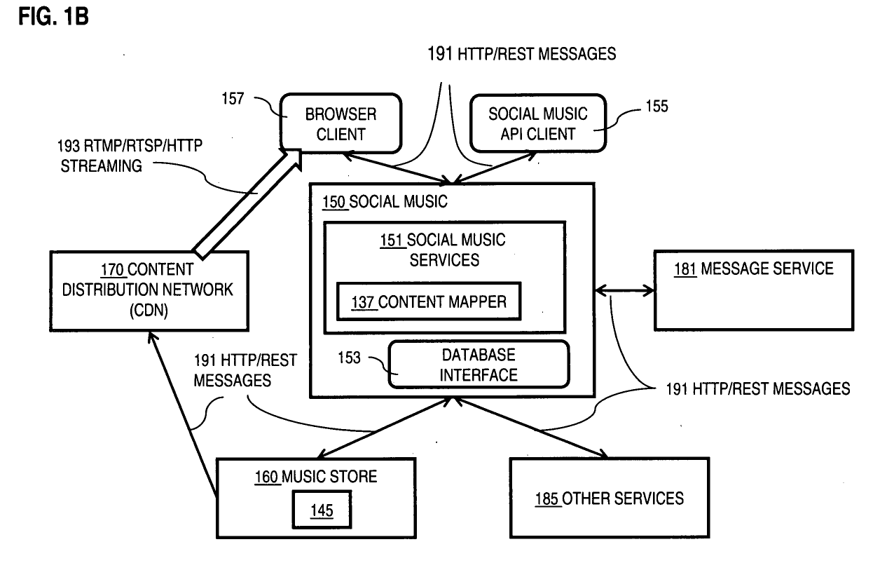

FIG. 1A is a diagram of a system for content mapping, according to an example embodiment. As shown in FIG. 1A, a system 100 includes a content service system 130 and a plurality of nodes (e.g., nodes 120, 131, 140) having connection with each other through a communication network 105. This system 100 supports efficient content sharing, particularly in the handling of metadata associated with the content.

One aspect of content sharing involves identifying the content to be downloaded to a local wired or wireless device, and finding a source for that content on the network that is available to the local device. Another aspect of content sharing is obtaining rich metadata about the content, such as release date, links to sites where the content can be purchased, links to sites where the content can be downloaded after purchase, links to sites where ancillary materials (e.g., trailers and cover art) can be found, and a database identifier for the content, among many others.

According to certain embodiments, the content mapping to metadata is performed, at least in part, when a user requests the content. Such mapping is referred to as on-demand content mapping, which provides a number of advantages. For example, burden on a content service is reduced by avoiding mapping for content that is never requested. Also, up-to-date metadata for content that is requested may be readily obtained. In certain embodiments, metadata can be represented as a collection of one or more values for corresponding parameters that are useful to describe content.

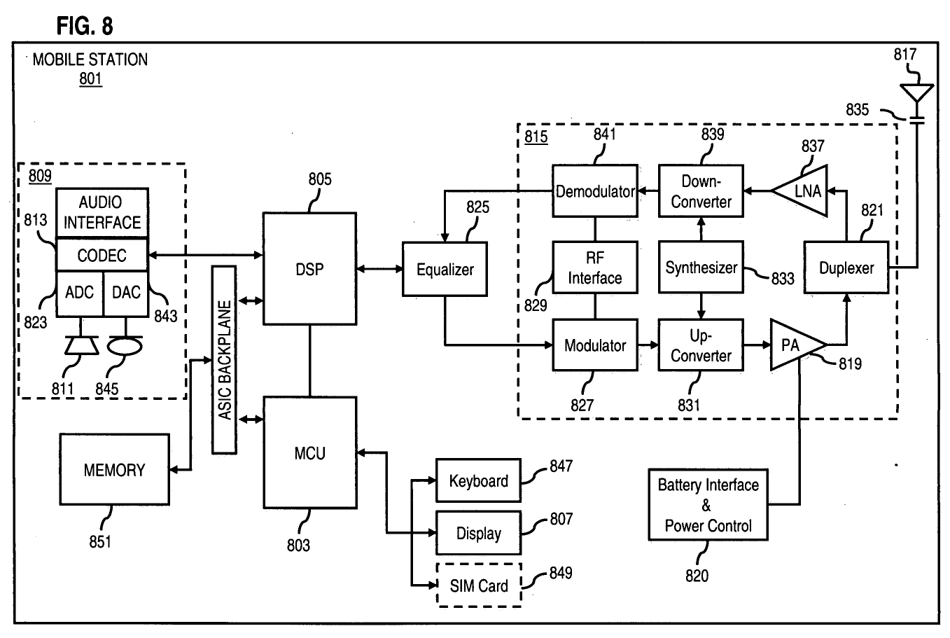

Nodes 120, 131, 140 of FIG. 1 can be any type of fixed terminal, mobile terminal, or portable terminal including desktop computers, laptop computers, handsets, stations, units, devices, multimedia tablets, Internet nodes, communicators, Personal Digital Assistants (PDAs), or any combination thereof. Moreover, the nodes may have a hard-wired energy source (e.g., a plug-in power adapter), a limited energy source (e.g., a battery), or both. It is further contemplated that the nodes 120, 131, 140 can support any type of interface to the user (such as “wearable” circuitry, etc.). In the illustrated embodiment, node 120 is a wireless mobile terminal (also called a mobile station and described in more detail below with reference to FIG. 8). The mobile terminal 120 is connected to network 105 by a wireless link 107.

By way of example, the communication network 105 of system 100 can include one or more networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

Information is exchanged between network nodes system 100 according to one or more of many protocols (including, e.g., known and standardized protocols). In this context, a protocol includes a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

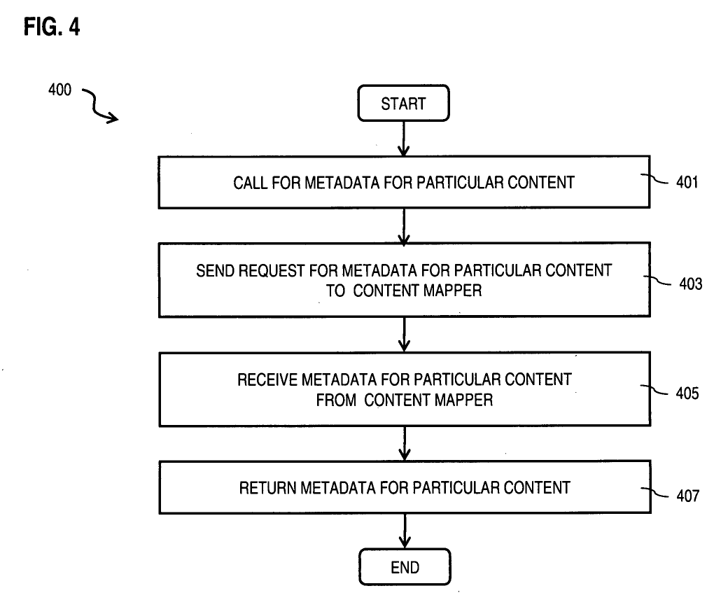

The mobile terminal 120 includes a data structure with mobile content 123, and a content player process 121 and content client process 127. The content player process 121 is operative to play content from the mobile content data structure 123 in response to input by a user (not shown). According to the illustrated embodiment, the mobile terminal includes content client process 127 that communicates with the content service system 130 over the network 105. The content client process 127 includes a content mapper client 129 that is operative to obtain metadata about content already, or yet to be, downloaded to the mobile terminal 120. The operation of content mapper client 129 is described in greater detail below with reference to FIG. 4.

The content service system 130 includes one or more content service hosts 131 and a content database 132. The content service hosts are connected directly or indirectly to network 105. The content database 132 resides on one or more nodes connected directly or indirectly to the content service hosts 131, and it is anticipated that, in some embodiments, content database 132 resides on one or more nodes in network 105. The content database 132 includes one or more processes (not shown) and one or more data structures, including one or more local content data structures 139 that store content, and a local metadata data structure 135 that sores information about the local content.

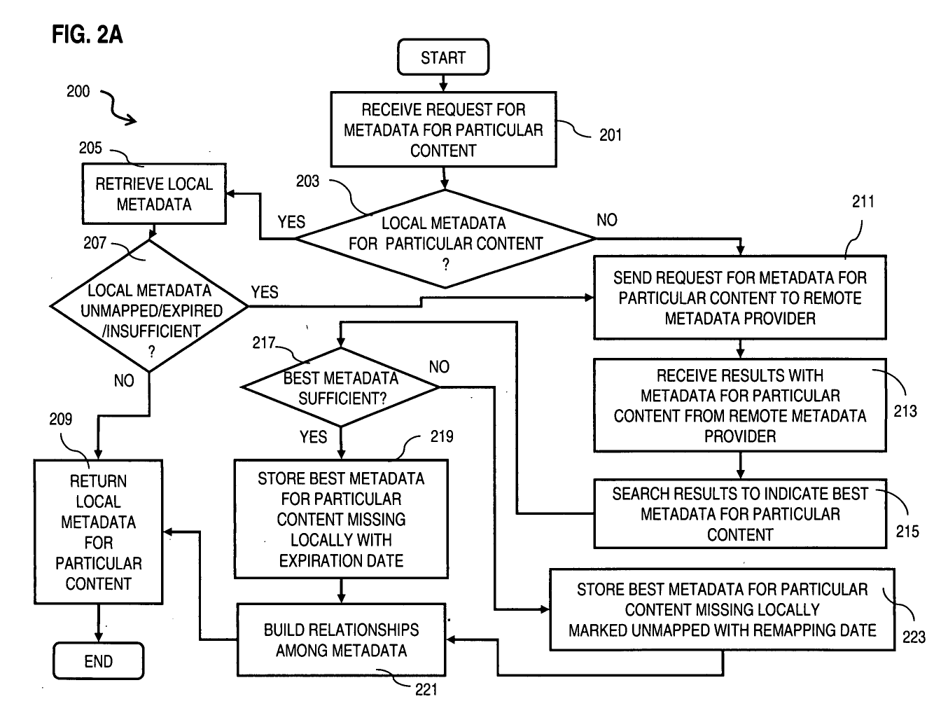

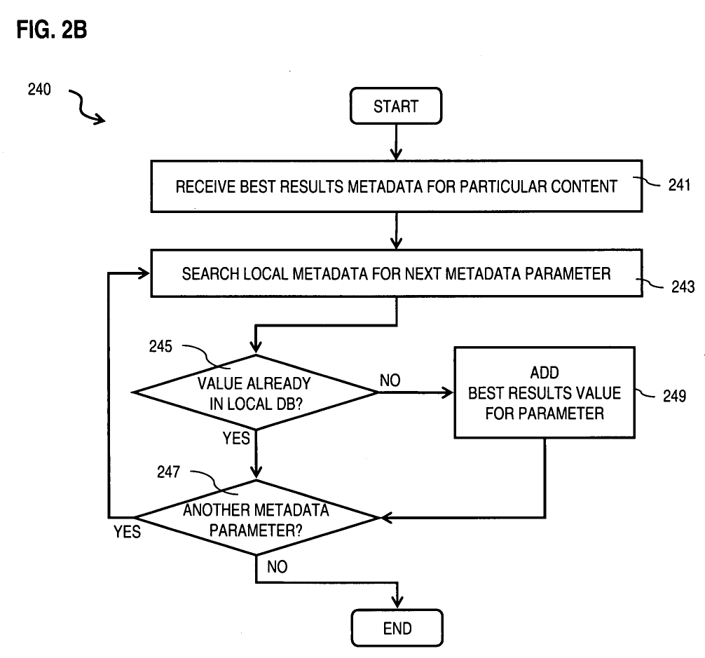

The content service hosts 131 are one or more network nodes that support the content service module 133. The content service module 133 is a process that supports users in finding and playing content on their devices in communication with the network 105. In the illustrated embodiment, the content service module 133 includes a content mapper process 137, the operation of which is described in greater detail below with reference to FIG. 2A and FIG. 2B.

According to one embodiment, it is understood herein that local content in local content data structures 139 and local metadata in local metadata data structures 135 are local in the sense that they are controlled by content mapper 137, and that the content mapper has permission to write to and otherwise edit the data in these data structures. As stated above, the actual data may reside on one or more nodes different from the host of the content mapper 137, and in communication with the content mapper 137 directly, as depicted, or via network 105.

The system 100 includes a content store process 145 on a content store host 140 connected to network 105. In one embodiment, a content store 145 resides on multiple hosts connected directly or indirectly to network 105. In some embodiments, the content store 145 is included in the content service system 130. One or more content store hosts 140 host remote content data structures 141 and remote metadata data structures 143. The content store process 145 includes a metadata provider process 147. The metadata provider process 147 is adapted to provide metadata from the remote metadata data structure 143 in response to a request for metadata associated with particular content, if metadata for that content is in the metadata data structure 143. The NOKIA™ Music Store (NMS) is an example of a content store 145 that resides on one or more hosts connected to a communications network.

In many networks, communications between nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

Although a particular set of nodes, processes, and data structures are shown in FIG. 1A for purposes of illustration, in various other embodiments more or fewer nodes, processes and data structures are involved. Furthermore, although processes and data structures are depicted, in FIG. 1A and following drawings, as particular blocks in a particular arrangement on particular nodes for purposes of illustration, in other embodiments each process or data structure, or portions thereof, may be separated or combined or arranged in some other fashion on one or more nodes. For example, in one embodiment, content mapper 137 is a separate parallel process from content service process 133; and in one embodiment, metadata provider 147 is a separate parallel process from content store process 145. In a embodiment, content client 127 is incorporated in content player process 121.

FIG. 1B is a diagram of components of a content service module of the content service system 130, according to an example embodiment. FIG. 1B also shows interaction between the content service module (e.g., content service process 133) and other processes on a network.

In the illustrated embodiment, the content service module is called Social Music module 150 and supports users in finding and playing music on their local devices in communication with the network. The Social Music module 150 includes Social Music services 151 and a database interface process 153. The Social Music services are a set of applications (e.g., a JAVA™ stack written in the JAVA™ programming language that can be installed and executed on any device that includes a JAVA™ virtual machine (JVM) process). The Social Music services include processor instructions for finding metadata about songs and using the metadata to direct users to resources on the network where the user can purchase or download those songs, or both. The database interface process 153 is the interface between the Social Music module 150 and the local content database 132; and is used to retrieve and store local metadata 135, and to retrieve and store local content 139.

In the illustrated embodiment, the Social Music services include content mapper process 137 to obtain metadata for content and to use the database interface process 153 to store and retrieve the local metadata in the local metadata data structures 135.

The Social Music module 150 interacts with other processes on the network (e.g., network 105) using the hypertext transfer protocol (HTTP), often in concert with the Representational State Transfer (REST) constraints. The other processes may be on the same node or on different nodes.

In the illustrated embodiment, a user's device (e.g., mobile terminal 120) includes a Social Music application program interface (API) client 155 (a music-oriented embodiment of content client 127) to interact with the Social Music module 150, and a browser client 157 to interact with World Wide Web pages using HTTP. The Social Music module 150 interacts with one or more Music Store systems 160, such as the NOKIAT Music Store or music store 160, to purchase songs to be downloaded to a user's device. The download is often accomplished using a Content Distribution Network (CDN) 170. The music store authorizes the CDN 170 to download to the user; and then directs a link on the user's browser client 157 to request the content from the CDN 170. The content is delivered to the user through the user's browser client 157 as data formatted, for example, according to HTTP or the real-time messaging protocol (RTMP) or the real-time streaming protocol (RTSP), all well known in the art. As a result, the content is stored on the user's device (e.g., as mobile content 123 on mobile terminal 120). The mobile content 123 arrives on the mobile terminal 120 either directly from the CDN 170, or indirectly through some other device, e.g., a wired node (not shown) using a temporary connection (not shown) between mobile terminal 120 and wired node.

In some embodiments, the Social Music module 150 uses a message service 181 (such as the MICROSOFT™ YUKON™ service), to receive event data about playback events on the user's device. In some embodiments, the Social Music module 150 uses other services 185 available on the network (e.g., network 105) such as people services to connect with other persons in a Social Music group of persons, map services to show a user's location and points of interest on a map, and game services to determine the user's status in one or more games.

According to the illustrated embodiment, a system of processes to update metadata on demand includes the content mapper process 137 in the content service system 130. FIG. 2A is a flowchart of a process 200 for content mapping, e.g., for determining when and how to update metadata associated with content, according to one embodiment. Although steps in FIG. 2A and subsequent flow charts, FIG. 2B and FIG. 4, are shown in a particular order for purposes of illustration, in other embodiments, one or more steps may be performed in a different order or overlapping in time, in series or in parallel, or one or more steps may be omitted or added, or changed in some combination of ways.

In step 201, a request for metadata for particular content is received. Any method may be used to receive this request For example, in some embodiments, a playback event message is received that indicates a user is playing the particular content on the user's device. The user's music player program wants the metadata to display on the user's device display. In some embodiments, a request is received for particular content, e.g., a particular song, and metadata is desired to determine where to purchase and download the content. In some embodiments, a request is received for metadata about a song on another user's playlist that the current user is curious about. In various embodiments, the requests originate in the content player process 121 or the content client 127 or the content mapper client 129. In the illustrated embodiment, the content mapper client detects an attempt to use metadata and sends the request to the content mapper process 137.

In response to receiving the request for metadata, in step 203, it is determined whether there is local metadata for the content. If so, then the local metadata is retrieved as in step 205. In practice there is a finite set of metadata parameters of interest for describing content. There is local metadata for the content if there is a value for at least one of the metadata parameters, including those that are used to identify the content. So, if values for a song title and artist name (two metadata parameters) are used to identify content, then there is metadata for the particular song performed by the particular artist, if there is a value for either of these or for any other parameters linked to these values, such as an album name, a web link for purchase, or a web link for download.

In step 207, it is determined whether the local metadata has expired or is marked unmapped or is insufficient.

The local metadata has expired if data indicating an expiration time is associated with the particular content and the current time is after the expiration time. An expiration date is set in some embodiments, as described in more detail below, to improve metadata, to prevent metadata from becoming stale, or to provide an opportunity to correct any errors that might have been introduced. For example, an expiration date one month or one year after local metadata is last updated is used for this purpose. The data indicating the expiration date can be the date the local metadata was last updated; in which case the expiration date is implied one month (or one year, or some other certain time) after the date the metadata was updated. In some embodiments, the stored data indicating the expiration date can be the date the local metadata is set to expire; in which case the expiration date is explicit. In these embodiments, a list of metadata parameters includes at least one of an update date and an expiration date.

In an embodiment, the local metadata is marked as unmapped if sufficient metadata is not obtained from a metadata provider. Any measure may be used to determine if metadata is sufficient. For example, metadata for certain content is not sufficient in some embodiments, when there is no value for a metadata parameter that indicates a web site where the certain content can be purchased. In some embodiments, metadata is sufficient even when it is not complete. For example, in one embodiment, song metadata is sufficient when it includes values for metadata parameters: song title; artist name; album name; a website where the song can be purchased; and a web site where the song can be downloaded; even if the metadata does not include a value for the metadata parameter that indicates a website where album cover art can be downloaded. A set of metadata parameters for which values must be available for the metadata to be sufficient is called herein a set of sufficient metadata parameters. In some embodiments, insufficient metadata received from a metadata provider is stored in the local metadata, is marked as unmapped, and also is scheduled for a subsequent attempt at retrieving metadata for the content from a metadata provider (“re-mapping”). The remapping is scheduled, for example, using a callback function in a background process to request metadata for the content at the scheduled time. In this embodiment, the callback issued request for metadata associated with the particular content comprises step 201, described above. In these embodiments, a list of metadata parameters includes at least one of an unmapped flag and remapping date.

The local metadata can be insufficient even if no request for metadata was ever placed with a metadata provider and thus the local metadata was never marked as “unmapped.” In this case, it is first determined that the local metadata is insufficient per step 207 in response to receiving a request in step 201.

If it is determined, in step 207, that the local metadata is neither unmapped nor expired nor insufficient, then, in step 209, a copy of the local metadata for the particular content requested in step 201 is returned to the process that requested the metadata, e.g., a content player process 121 or content mapper client 129 on mobile terminal 120. In some embodiments all local metadata is copied; and in others, only requested metadata parameter values are copied.

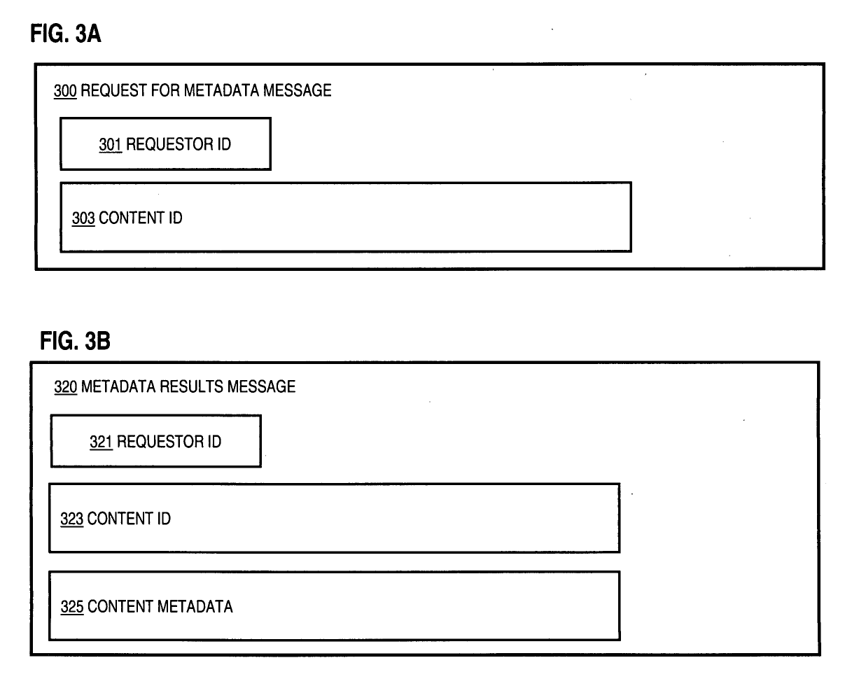

If it is determined, in step 207, that the local metadata is either unmapped or expired or insufficient, then, in step 211, a request for metadata associated with the particular content is generated and sent to a remote metadata provider process, e.g., metadata provider process 147 in content store 145. The request may be generated and sent in any manner known in the art. In some embodiments, a request message 300 as described in FIG. 3A is generated and sent to the metadata provider.

FIG. 3A is a diagram of a request for metadata message 300, according to one embodiment. The request for metadata message includes a requester identifier (ID) field 301 and a content identifier (ID) field 303. Although blocks of data are shown as contiguous fields in a particular order within a single message in FIG. 3A and subsequent diagrams for purposes of illustration, in other embodiments, one or more fields, or portions thereof, are arranged in a different order within one or more messages.

The requester ID field 301 holds data that indicates the process on a network that is making inquiry about particular content. For example, the requester ID indicates the content mapper process 137 in the content service system 130. In some embodiments, the requester ID is provided by a source IP address and a Transport Control Protocol (TCP) source port that sends the message 3A, which information is already carried in one or more fields of one or more headers of corresponding protocols, e.g., IP and TCP. In such embodiments, the fields on one or more protocol headers comprise requester ID field 301.

In some embodiments, a content mapper client 129 uses request for metadata message 300 to request metadata from content mapper 137 in the content service system 130. Then, the requester ID field 301 holds data that indicates the content mapper client 129 on mobile terminal 120.

The content ID field 303 holds data that indicates the particular content for which metadata is desired. Any method may be used to indicate the particular content in content ID field 303. In one embodiment, the content ID holds data that indicates a content name and a performer name. e.g., a song title and artist name. In one embodiment, the content ID field 303 holds data that indicates a unique database retrieval key for the content and a database name, such as a name for content database 132 or remote database, not shown, on remote hosts 140. In some embodiments, the message 300 includes a field (not shown) for a sequence number that can be used in a response message to indicate which request is being responded to.

Referring again to FIG. 2A, in step 211 a request, such as request message 300, is sent to a remote metadata provider, e.g., metadata provider 147 in content store 145. It is assumed for purposes of illustration that a unique database retrieval key on the remote metadata provider is not known by the requesting process, e.g., content mapper 137. Therefore, the content ID field holds data that otherwise describes the content, such as song title and artist name.

In step 213, result data (also called results herein) are received from the metadata provider in response to the request sent per step 211. In an example embodiment, the results include all the metadata that matches the data in the content ID field 303. For example, when the content ID field indicates a song title and an artist name, the results include metadata associated with the song title, no matter who performed it, and all metadata about the artist, no matter what songs were performed.

FIG. 3B is a diagram of a metadata results message 320, according to one embodiment. The metadata results message 320 includes a requester identifier (ID) field 301, a content identifier (ID) field 303, and a content metadata field 325. The requester ID field 321 carries data that indicates the process which requested the metadata and which is the destination of the current message. In some embodiments, this information is conveyed by fields in the IP and TCP protocol headers. The content ID field 323 holds data that indicates the content for which metadata was requested. In some embodiments, the requester ID field 321 and content ID field 323 are replaced by a sequence number field that holds data that matches a sequence number in a request message. The content metadata field 325 holds data that indicates the metadata retrieved by the process that originated message 320, e.g., by the metadata provider process 147. In an embodiment, the content metadata field 325 holds metadata associated with any descriptor used in the content ID field 303 in the request message 300. For example, in response to a request for metadata about a particular song sung by a particular artist, the content metadata field 325 holds data that indicates metadata retrieved by the metadata provider about multiple versions of the song performed by the particular artist as well as by other artists, and metadata about the particular artist, including other songs performed by, written by, produced by or backed up by the artist, and metadata about all albums on which the song or artist appears.

In some embodiments, the content mapper process 137 uses results message 320 to return metadata to content mapper client 129 in the mobile terminal 120. Then, the requester ID field 301 holds data that indicates the content mapper client 129 on mobile terminal 120.

Referring again to FIG. 2A, the results are received in step 213 from the remote metadata provider, e.g., metadata provider 147. In step 215, the results are searched for the best metadata about the particular content. For example, the results are sorted in order of relevance, and the most relevant metadata is selected as the best result. In one embodiment, the relevance measure indicates similarity to the values of the metadata parameters used as content descriptors in the content ID field 303 in the request message 300. In another embodiment, the relevance measure indicates similarity to the local metadata associated with the particular content (e.g., including information about album, release date or any other values for metadata parameters that appear in the local metadata).

In step 217 it is determined whether the best result metadata, when added to the local metadata, renders the local metadata sufficient. For example, it is determined whether the local metadata for the particular content combined with the best result metadata offers values for all the metadata parameters in the set of sufficient metadata parameters.

If so, the best result metadata for the particular content is stored in step 219. In the illustrated embodiment the best metadata is only stored for metadata parameters that do not already have (non-null) values in the local metadata, i.e., only for metadata parameters that are absent or are present with null values in the local metadata, as described in more detail with reference to FIG. 2B. In the illustrated embodiment, data indicating an expiration data is also added to the local metadata for the particular content, to ensure that the local metadata is refreshed on occasion. In some embodiments, after the expiration date, the best result metadata are allowed to replace the local metadata even for metadata parameters that have non-null values.

In step 221, relationships are built among the values in the local metadata. For example: an association is recorded between a song and an artist that performed the song; and an album identified by album name is associated with a linked list of songs and artists.

Per step 209, a copy of the local data is returned to the requesting process, as described above.

If it is determined in step 217 that the local data is not sufficient even when combined with the best result metadata, then the best result metadata for the particular content is stored in step 223 and marked unmapped. In the illustrated embodiment, the best result metadata is only stored for metadata parameters with null values in the local metadata, as described in more detail below with reference to FIG. 2B. Relationships are built in step 221; and a copy of the local data is returned to the requesting process in step 209.

Thus, as depicted in FIG. 2A, a search is imitated for local metadata associated with a particular content; and it is determined whether the local metadata is insufficient. A request for metadata associated with the particular content is generated if the local metadata is insufficient; and sending the request to a metadata service is initiated to obtain result data including metadata for the particular content. Search of the result data from the metadata service is initiated based on a description of the particular content to obtain most relevant metadata of the result data. The local metadata is updated based on the most relevant data.

FIG. 2B is a flowchart of a process 240 for one or more steps of the content mapping process 200 of FIG. 2A, according to one embodiment. Process 240 is an embodiment of portions of step 219 and step 223 to update the local data based on the best result metadata; and includes steps 241 through 247. In step 241 the best result metadata for particular content is received, e.g., as a result of a selecting the most relevant metadata in the results. In step 243, the local metadata is searched for the next metadata parameter associated with the particular content.

In step 245, it is determined whether the local metadata already has a non-null value for that parameter associated with the particular content. If so, it is determined in step 247 whether there is another metadata parameter to check. If not the process is finished. If so, then the local metadata is searched for the next parameter in step 243, described above. If it is determined in step 245, that the local metadata is absent or has a null value for that parameter, then, in step 249, the best result metadata value for that parameter is added to the local metadata for that parameter for the particular content.

By way of example, the following scenario is considered. First, a user listens to Metal Band—Our Rocking Band on mobile terminal 120 and content mapper client 129 requests metadata for this song, sending, e.g., message 300 to content mapper 137. However, there is neither an artist name Metal Band nor a song name Our Rocking Band in the local metadata database 135. Next, content mapper 137 searches the local metadata data structure 135 to find (Metal Band, Our Rocking Band) pair, and it is not there. The content mapper process 137 sends a request to metadata provider process 147. As a result, content mapper process 137 receives a results message (e.g., 320) that includes Metal Band Our Rocking Band in the content ID field 323 with album name Our Rocking Band II and values for other associated metadata parameters in the content metadata field 325. The content mapper process 137 stores the information in the local metadata data structure 135 (because none of these values are found in the local metadata data structure 135). As a consequence of this storing, there is in local metadata data structures 135 an artist Metal Band, who has album Our Rocking Band II which is linked to only one song, Our Rocking Band, on that album. The user subsequently listens to Metal Band—Rocking Out (that happens to be on the same album, Our Rocking Band II, as song Our Rocking Band). Content mapper client 129 requests metadata for this song from content mapper process 137. The content mapper process 137 searches the local metadata data structure 135 to find (Metal Band, Rocking Out) pair from database, and it is not there. The content mapper process 137 sends a request to metadata provider process 147. As a result, content mapper process 137 receives a results message (e.g., 320) that includes Metal Band, Rocking Out on album Our Rocking Band II with associated metadata. When the content mapper process does a search of the local metadata data structure 135 using Metal Band it finds the artist and the album Our Rocking Band II. So neither is updated based on the results. However, Rocking Out song search of local metadata data structure 135 does not give anything. Therefore the content mapper process 137 creates the missing song and forms a relationship with existing artist Metal Band and existing album Our Rocking Band II. Lastly, the local metadata includes one Metal Band artist with one Our Rocking Band II album that has two songs: Our Rocking Band and Rocking Out.

FIG. 4 is a flowchart of a process 400 for a content mapper client, according to one embodiment. In step 401, the content mapper client process detects a call (or request) for particular metadata for particular content. The particular metadata may include one, more or all the metadata parameters associated with content. For example, upon start of play of mobile content, the content player process 121 may call the content client 127 for the album name and album cover art that involves an album cover art link, thus effectively calling for values for two metadata parameters associated with a song being played. This call is detected by the content mapper client 129.

In step 403, the content mapper client 129 sends a request (e.g., message 300) for metadata for the particular content to the content mapper 137. In response, per step 405, the content mapper client 129 receives metadata for particular content from content mapper 137, e.g., in metadata results message 320. However, unlike some results from a metadata provider, only the most relevant results are returned to the content mapper client 129 by the content mapper process 137. For example, only the value of the album name and the value of the album cover art link are included in the content metadata field 325.

In step 407, the particular metadata for the particular content is returned to the process that called for it. For example the album name and link to the album cover art is returned to the content client 127. The content client may obtain the art using the link and send the art and album name to content player process 121 for presentation to the user.

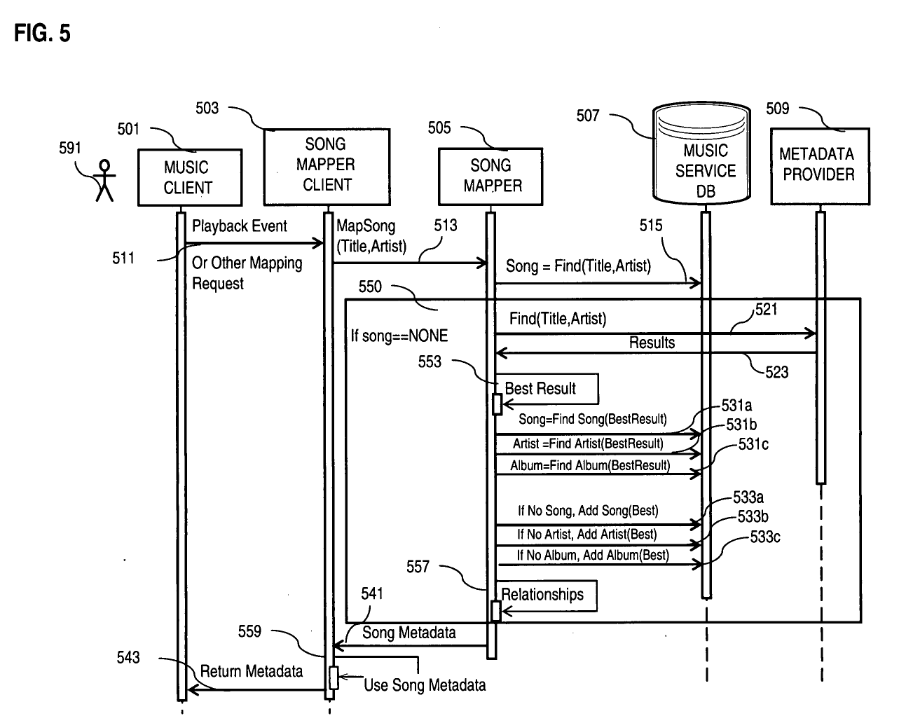

FIG. 5 is a time sequence diagram that illustrates a sequence of messages and processes for content mapping, according to one embodiment. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 5 are a music client 501 and song mapper client 503 on mobile terminal 120, a song mapper process 505, the music service database 507, and a metadata provider 509. The music client 501 is an example of a content client 127. The song mapper client 503 is an example of a content mapper client 129. The song mapper 505 is an example of a content mapper 137; and, the music service database 507 is an example of the local metadata 135 in content database 132. The metadata provider 509 is an example of the metadata provider 147. A human user 591 operates the music client 501, directly, or indirectly, e.g., through a music player.

In response to input from user 591, the music client 501 initiates a playback event or other mapping request, which is detected by song mapper client 503 as message 511. In response, the song mapper client sends a metadata request message 513 (e.g., formatted as request for metadata message 300) to the song mapper 505. The message 513 identifies the content of interest as the Song title and artist pair, e.g., in the content ID field 303 of the request message 300. The message 513 is characterized as a command “MapSong(Title,Artist)” from a Social Music application program interface (API) client 155 on the mobile terminal 120 to the Social Music module 150 wherein resides the content mapper 137.

The song mapper sends a message 515 to find the song in the local metadata. The message 515 is characterized as a database interface command “Song=Find(Title,Artist)” issued to a database interface 153 in the Social Music module 150. If the song is found, the song metadata is retrieved from the Music service database 507 and returned to the song mapper client 503 in message 541 at the bottom of the diagram, where it is used in process 559 to return the metadata desired by the music client 501 as message 543.

If the song is not found in the Music Service database 507 (e.g., if song==NONE), then the sub-process 550 is performed by the song mapper process 505. A request is made to find the Title and Artist at the metadata provider 509 by sending request message 521, e.g., formatted as request for metadata message 300. The message 521 is characterized as database interface command “Find(Title,Artist)” from a database interface 153 in the Social Music module 150. The results are returned in one or more messages 523, e.g., formatted as metadata results message 320.

The results are searched for the best result in step 553, e.g., by sorting in terms of relevance, as a music example of step 215, described above. The metadata of interest is extracted from the best result. For purposes of illustration, it is assumed simply that three metadata parameters are of interest: song name, artist name and album name. Extracting the values for these three parameters is represented in FIG. 5 by the three database interface commands Song=Find Song(BestResult) 531a, Artist=Find Artist(BestResult) 531b and Album=Find Album(BestResult) 531c.

Subsequently, the local metadata is searched for the same metadata parameters of interest. If there is no value, then the best result for that parameter is added to the local metadata, as described above with reference to process 240 in FIG. 2B. In FIG. 5, the test and result are represented by the 3 database commands: If No Song, Add Song(Best) 533a; If No Artist, Add Artist(Best) 533b; and, If No Album, Add album(Best) 533c.

In step 557, the song mapper forms relationships among the added values and the original data in the local metadata, as described above with reference to step 221 in FIG. 2A.

The song metadata from the local metadata is then sent in message 541 to the song mapper client 503, formatted e.g., as metadata results message 320. The song mapper client 503 uses this metadata in step 559, to pick out the metadata to satisfy the music client 501, and sends this metadata in message 543 to the music client 501, as described above with reference to step 407 of FIG. 4. This metadata affects a display presented to user 591.

The processes described herein for on-demand content mapping may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

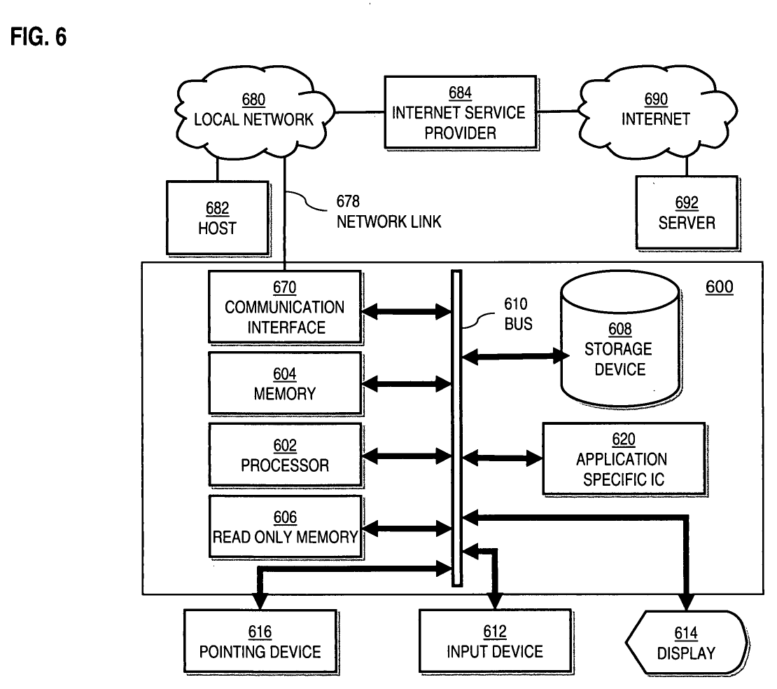

FIG. 6 illustrates a computer system 600 upon which an embodiment of the invention may be implemented. Computer system 600 includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information. The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690. A computer called a server host 692 connected to the Internet hosts a process that provides a service in response to information received over the Internet. For example, server host 692 hosts a process that provides information representing video data for presentation at display 614.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

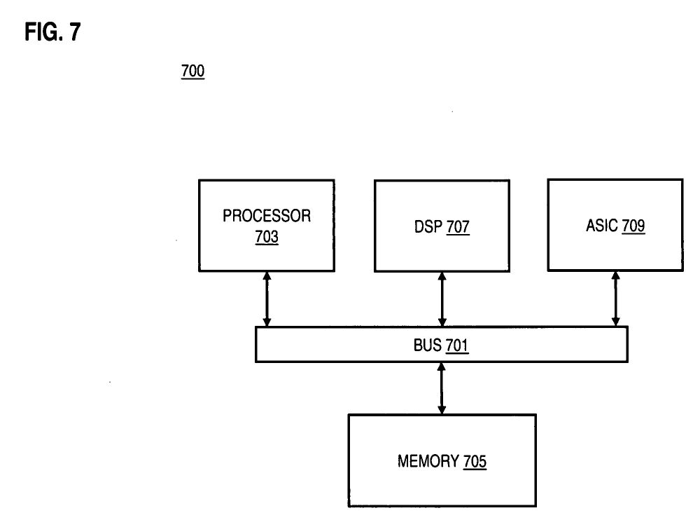

FIG. 7 illustrates a chip set 700 upon which an embodiment of the invention may be implemented. Chip set 700 is programmed to carry out the inventive functions described herein and includes, for instance, the processor and memory components described with respect to FIG. 7 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-word signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein. The memory 705 also stores the data associated with or generated by the execution of the inventive steps.

FIG. 8 is a diagram of example components of a mobile station (e.g., handset) capable of operating in the system of FIG. 1A, according to an example embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803-which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A computer-readable storage medium carrying one or more sequences of one or more instructions which, when executed by one or more processors, cause the one or more processors to at least perform the following steps:
initiating a search for local metadata associated with a particular content;
determining whether the local metadata is insufficient;
generating a request for metadata associated with the particular content, if the local metadata is insufficient;
initiating sending the request to a metadata service to obtain result data including metadata for the particular content; and
determining most relevant metadata of the result data.

2. A computer-readable storage medium of claim 1, wherein the one or more processors are caused to perform steps further comprising:
initiating storage of metadata based on the most relevant metadata; and
initiating sending to a client process a message that indicates metadata based on the most relevant metadata.

3. A computer-readable storage medium of claim 2, wherein initiating the storage of metadata based on the most relevant data further comprises initiating the storage of values from the most relevant metadata only for metadata parameters that do not already have a value associated with the particular content in the local metadata.

4. A computer-readable storage medium of claim 1, wherein the one or more processors are caused to perform steps further comprising initiating sending, to a client process, a message that indicates the local metadata, if the local metadata is sufficient.

5. A computer-readable storage medium of claim 1, wherein the one or more processors are caused to perform steps further comprising:
initiating storage of the most relevant metadata into the local metadata;
determining whether the local metadata is still insufficient after storage of the most relevant metadata into the local metadata; and
initiating marking as unmapped the local metadata associated with the particular content, based on determining that the local metadata is still insufficient after storage of the most relevant metadata.

6. A computer-readable storage medium of claim 5, wherein determining whether the local metadata is insufficient further comprises determining whether the local metadata associated with the particular content is marked unmapped.

7. A computer-readable storage medium of claim 2, wherein initiating the storage of the most relevant metadata further comprises initiating the storage of data that indicates an expiration time based on a time when the result data associated with the particular content was sent from the metadata service.

8. A computer-readable storage medium of claim 7, wherein determining whether the local metadata is insufficient further comprises determining whether the local metadata associated with the particular content is marked with data that indicates an expiration time before a current time.

9. A computer-readable storage medium of claim 1, wherein initiating the search for local metadata associated with the particular content is performed in response to receiving from a client process a request for data about the particular content.

10. A computer-readable storage medium of claim 1, wherein the particular content is audio data for a song identified by particular values for metadata parameters that indicate artist name and song name, and the local metadata is sufficient if the local metadata includes a value for at least one different metadata parameter selected from a group of metadata parameters that indicate unique music store identifier for artist, unique music store identifier for the song, album name, link to a web page where the song can be purchased, link to a streaming media source to download the song, link to a web page with album art, duration of the song, date of release, country of release, another artist who performed the song, and another song performed by an artist indicated in the artist name.

11. An apparatus comprising a processor and a memory storing executable instructions that if executed cause the apparatus to at least perform the following:
initiating a search for local metadata associated with a particular content;
determining whether the local metadata is insufficient;
generating a request for metadata associated with the particular content, if the local metadata is insufficient;
initiating sending the request to a metadata service to obtain result data including metadata for the particular content; and
determining most relevant metadata of the result data.

12. An apparatus of claim 11, wherein the processor and the memory are further configured to perform initiating:
storage of metadata based on the most relevant data; and
sending to a client process a message that indicates metadata based on the most relevant metadata.

13. An apparatus of claim 12, wherein initiating the storage of metadata based on the most relevant data further comprises initiating the storage of values from the most relevant metadata only for metadata parameters that do not already have a value associated with the particular content in the local metadata.

14. An apparatus of claim 11, wherein the processor and the memory are further configured to perform initiating sending, to a client process, a message that indicates the local metadata, if the local metadata is sufficient.

15. An apparatus of claim 11, wherein the processor and the memory are further configured to perform:
initiating storage of the most relevant metadata into the local metadata;
determining whether the local metadata is still insufficient after storage of the most relevant metadata into the local metadata; and
initiating marking as unmapped the local metadata associated with the particular content, based on determining that the local metadata is still insufficient after storage of the most relevant metadata.

16. An apparatus of claim 15, wherein determining whether the local metadata is insufficient further comprises determining whether the local metadata associated with the particular content is marked unmapped.

17. An apparatus of claim 12, wherein initiating the storage of the most relevant metadata further comprises initiating the storage of data that indicates an expiration time based on a time when the result data associated with the particular content was sent from the metadata service.

18. An apparatus of claim 17, wherein determining whether the local metadata is insufficient further comprises determining whether the local metadata associated with the particular content is marked with data that indicates an expiration time before a current time.

19. An apparatus of claim 11, wherein initiating the search for local metadata associated with the particular content is performed in response to receiving from a client process a request for data about the particular content.

20. A method comprising:
initiating a search for local metadata associated with a particular content;
determining whether the local metadata is insufficient;
generating a request for metadata associated with the particular content, if the local metadata is insufficient;
initiating sending the request to a metadata service to obtain result data including metadata for the particular content; and
determining most relevant metadata of the result data.
